(19) United States
(12) Patent Application Publication
(10) Pub. No.: US 2013/0002428 A1
(43) Pub. Date: Jan. 3, 2013

(54) HIDDEN BURGLAR ALARM DEVICE FOR A DOOR OR WINDOW

(76) Inventor: Yu-Kong Chiu, Kaohsiung City (TW)

(21) Appl. No.: 13/170,262

(22) Filed: Jun. 28, 2011

(51) Int. Cl. G08B 13/08

(52) U.S. Cl. 340/545.1

(57) ABSTRACT

A hidden burglar alarm device for a door or window includes a casing, an alarm mechanism mounted in the casing, a separator detachably inserted into the casing, a magnetic set detachably connecting the separator to the casing, a connector connected with the separator, a ballast fixed on the connector and a flexible wire connected with the ballast. The alarm mechanism includes an alarm member and a trigger connected with the alarm member. The separator selectively abuts against the trigger. The magnetic set includes a metallic object fixed on the separator and a magnet portion fixed on the casing for magnetically attracting the metallic object. The connector has two ends respectively fixed on the separator and the ballast. The flexible wire has two ends respectively fixed on the ballast and a door or window.

### BACKGROUND OF THE INVENTION

1. Field of the Invention

The present invention relates to an alarm device, and more particularly to a hidden burglar alarm device for a door or window.

2. Description of Related Art

A conventional burglar alarm device for a door or window substantially utilizes a contacting magnetic reed switch or an infrared sensor alarm. However, the conventional burglar alarm device has the following drawbacks:

1) The contacting magnetic reed switch is usually installed aside from the door/window such that the contacting magnetic reed switch will be easily observed and broken by a burger.

2) The contacting magnetic reed switch is structurally limited. The contacting magnetic reed switch can be easily installed aside from the door/window but not installed on a rolling door. When the rolling door is scrolled, the contacting magnetic reed switch will be easily broken.

3) The infrared sensor alarm has various dead spots and easily sets off false alarms due to misidentification. If a cat or dog passes the infrared sensor alarm, the infrared sensor alarm may misidentify the cat or dog as an intruder and will be actuated and cause an error reaction.

4) The infrared sensor alarm is usually installed inside the house to avoid the possible misidentification of the infrared sensor alarm. When the infrared sensor alarm is actually actuated by the thief, the burger has already broken the door/window and invaded into the house. Therefore, the conventional burglar alarm device is not practical.

To overcome the shortcomings, the present invention tends to provide a burglar alarm device to mitigate or obviate the aforementioned problems.

### SUMMARY OF THE INVENTION

The main objective of the invention is to provide an improved burglar alarm device for a door or window. The alarm device includes a casing, an alarm mechanism mounted in the casing, a separator detachably inserted into the casing, a magnetic set detachably connecting the separator to the casing, a connector connected with the separator, a ballast fixed on the connector and a flexible wire connecting the ballast with a door/window. The alarm mechanism includes an alarm member and a trigger connected with the alarm member. The separator selectively abuts against the trigger. The magnetic set includes a metallic object fixed on the separator and a magnet portion fixed on the casing for magnetically attracting the metallic object on the casing. The connector has one end fixed on the separator and the other end fixed on the ballast. The flexible wire has one end fixed on the ballast and the other end to be fixed on a door/window.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a hidden burglar alarm device for a door or window in accordance with the present invention;

FIG. 2 is a partially enlarged perspective view of the hidden burglar alarm device in FIG. 1;

FIG. 3 is a partially exploded perspective view of the hidden burglar alarm device in FIG. 2;

FIGS. 4-5 are operational side views of the hidden burglar alarm device;

FIG. 6 is a partially top view of the hidden burglar alarm device showing diameters of a bolt, a positioning plate and a through hole;

FIG. 7 is a perspective view showing the hidden burglar alarm device utilized on a door plank;

FIG. 8 is a perspective view showing the hidden burglar alarm device utilized on a window frame; and

FIG. 9 is a perspective view showing the hidden burglar alarm device utilized on a rolling door.

### DETAILED DESCRIPTION OF PREFERRED EMBODIMENT

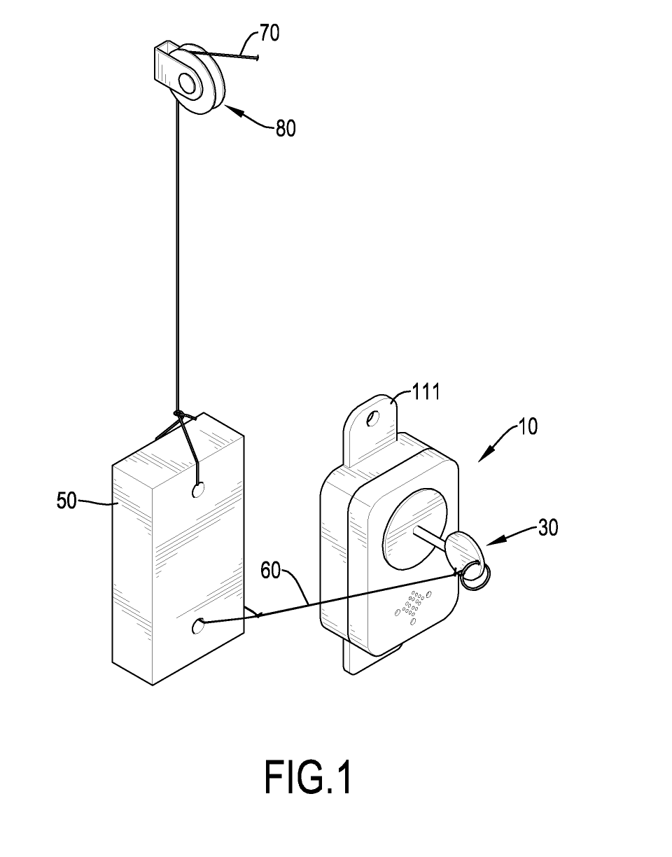

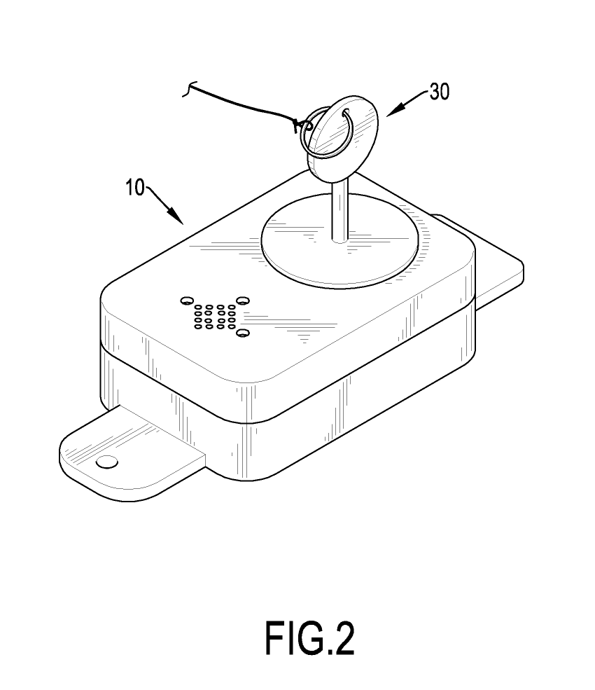

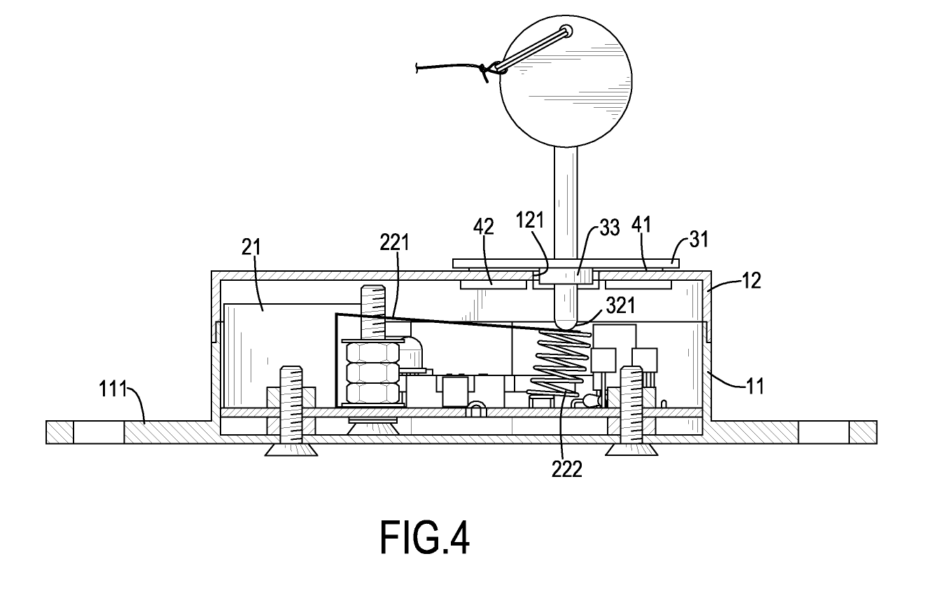

With reference to FIGS. 1 to 4, the hidden burglar alarm device for a door or window of the present invention comprises a casing 10, an alarm mechanism 20 mounted in the casing 10, a separator 30 detachably mounted on the casing 10, a magnetic set 40 detachably connecting the separator 30 to the casing 10, a connector 60 connected with the separator 30, a ballast 50 fixed on the connector 60 and a flexible wire 70 connecting the ballast 50 with a door/window.

The casing 10 is a hollow plastic rectangular structure and includes a base 11 and a cover 12 mounted on the base 11. The base 11 has two ears 111 respectively disposed on two opposite sides of the base 11. The cover 12 has an outer side, an inner side opposite to the outer side and a through hole 121 defined through the outer side and the inner side of the cover 12.

The alarm mechanism 20 is fixed on an inner bottom of the base 11 and includes an alarm member 21 and a trigger 22 connected with the alarm member 21. In the preferred embodiment of the present invention, the alarm member 21 is a buzzer.

The trigger 22 includes a reed 221 and a coil spring 222. The reed 221 is horizontally positioned in the base 11 and has an actuating portion 2211 extending from the reed 221, such that the reed 221 and the actuating portion 2211 are formed as an L-shaped structure. The coil spring 222 is connected with the alarm member 21 and mounted on a bottom of the actuating portion 2211 of the reed 221. The actuating portion 2211 is pivoted up and down to contact the coil spring 222 for switching on/off the alarm member 21. The alarm member 21 may be a conventional mechanism, so the structure and the principle of the alarm member 21 are not detailedly described.

The separator 30 is detachably inserted into the through hole 121 of the cover 12 and abuts against the trigger 22. The separator 30 includes a plastic restricting disc 31, a plastic bolt 32, a positioning plate 33 and a ring 34. The restricting disc 31 is provided for abutting against the outer side of the casing 10. The bolt 32 penetrates through the restricting disc 31 to be detachably and partially inserted into the through hole 121 in the casing 10. The bolt 32 has an abutting end 321 and a connecting end 322 opposite to the abutting end 321. The abutting end 321 tightly abuts against the actuating portion 2211 of the reed 221 to press the actuating portion 2211 to be bent downward. The connecting end 322 is formed as a rounded plate.

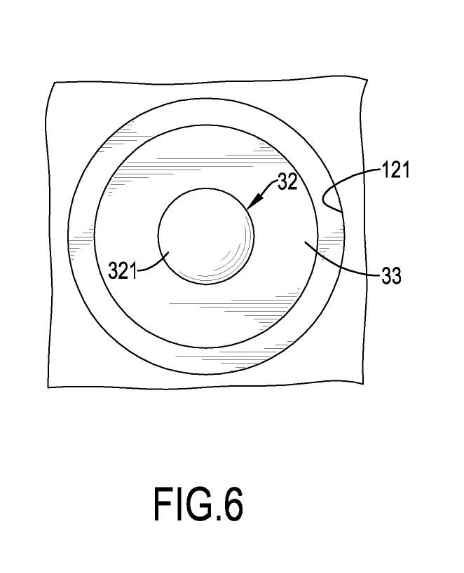

The positioning plate 33 is mounted on the restricting disc 31 and sleeved on the bolt 32 such that the positioning plate 33 is located between the abutting end 321 of the bolt 32 and the restricting disc 31 and selectively received in the through hole 121. The positioning plate 33 has a maximum outer diameter being smaller than a minimum inner diameter of the through hole 121. Preferably, as shown in FIG. 6, the maximum outer diameter of the positioning plate 33 is two times greater than a minimum outer diameter of the bolt 32 and the length of the minimum inner diameter of the through hole 121 is 2.2 to 2.3 times of the length of the minimum outer diameter of the bolt 32. Each of the outer diameters of the bolt 32 and of the positioning plate 33 is related to the inner diameter of the through hole 121. The inner diameter of the through hole 121 should be greater than each of the outer diameters of the bolt 32 and of the positioning plate 33 such that the abutting end 321 of the bolt 32 is easily detachable from the through hole 121.

The ring 34 penetrates through the connecting end 322.

The magnetic set 40 includes a metallic object 41 fixed on the separator 30 and a magnet portion 42 fixed on the casing 10 for magnetically attracting the metallic object 41 on the casing 10. Preferably, the magnet portion 42 includes three rounded magnets adhered on the inner side of the cover 12 and located around the through hole 121. The metallic object 41 is an iron ring adhered on the restricting disc 31 and is attracted by the magnet portion 42 to be magnetically attached on the outer side of the cover 12.

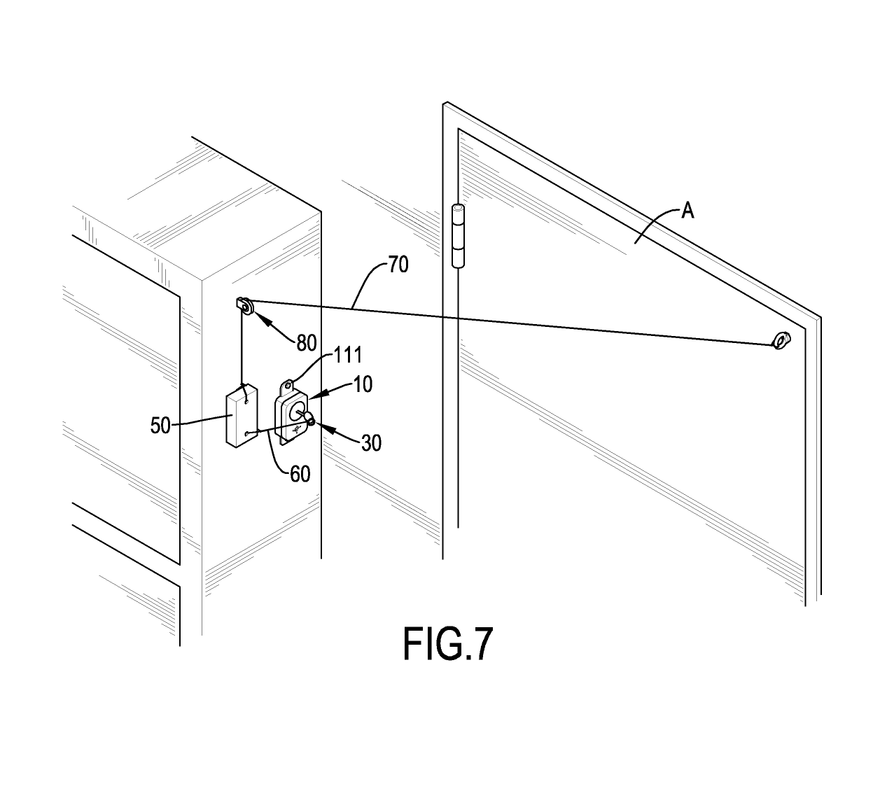

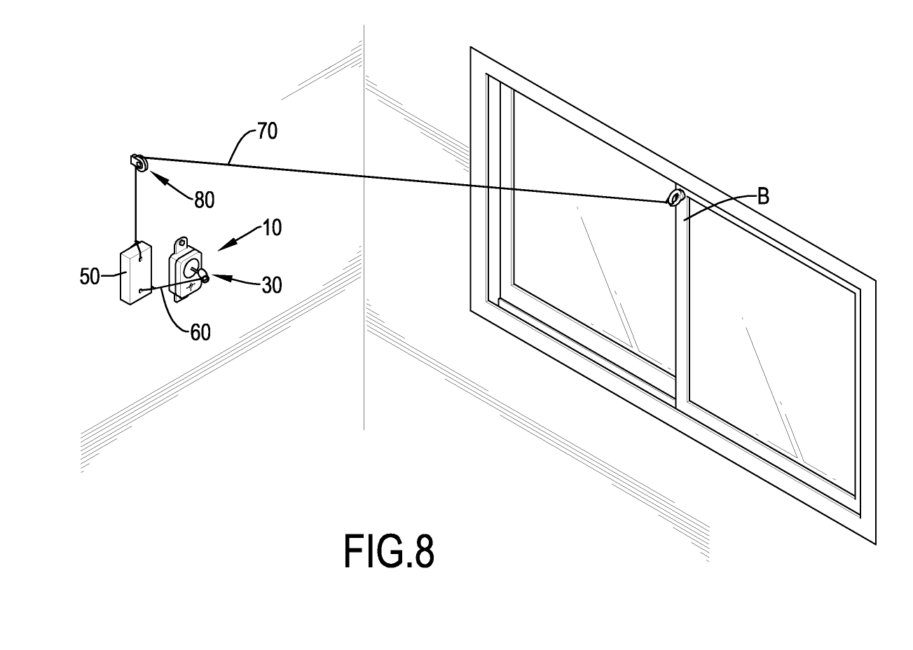

With reference to FIGS. 7 and 8, the connector 60 has one end fixed on the connecting end 322 of the separator 30 and the other end fixed on the ballast 50. The flexible wire 70 has one end fixed on the ballast 50 and the other end fixed on the door/window. Preferably, the connector 60 is a flexible wire having two ends respectively fixed on the ballast 50 and the ring 34. In addition, the hidden burglar alarm device of the present invention further has a pulley cooperating with the wire 70. The wire 70 is mounted around the pulley 80 such that the pulley 80 guides the wire 70 and changes a direction in which the wire 70 is pulled.

With reference to FIGS. 7 and 8, in operation, the two ears 111 of the casing 10 are attached on a closet or a bookrack with fasteners for fixing the casing 10. The pulley 80 is fixed above the casing 10. A free end of the wire 70 can be fixed on a door plank A (as shown in FIG. 7) or fixed on a window frame B (as shown in FIG. 8). When a burglar opens the door or the window to release the wire 70, the ballast 50 drops down to pull the separator 30 such that the separator 30 is detached from the casing 10.

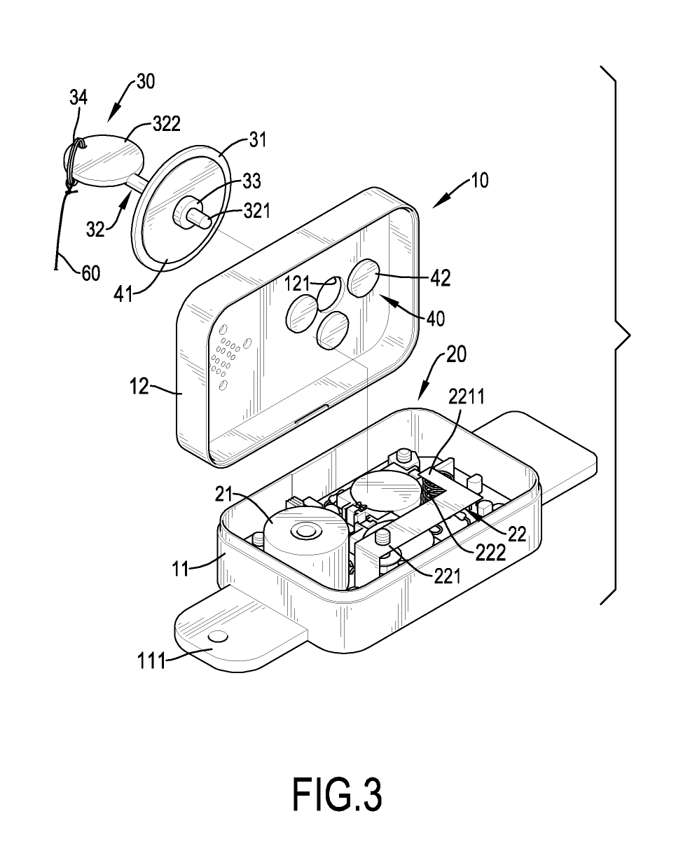

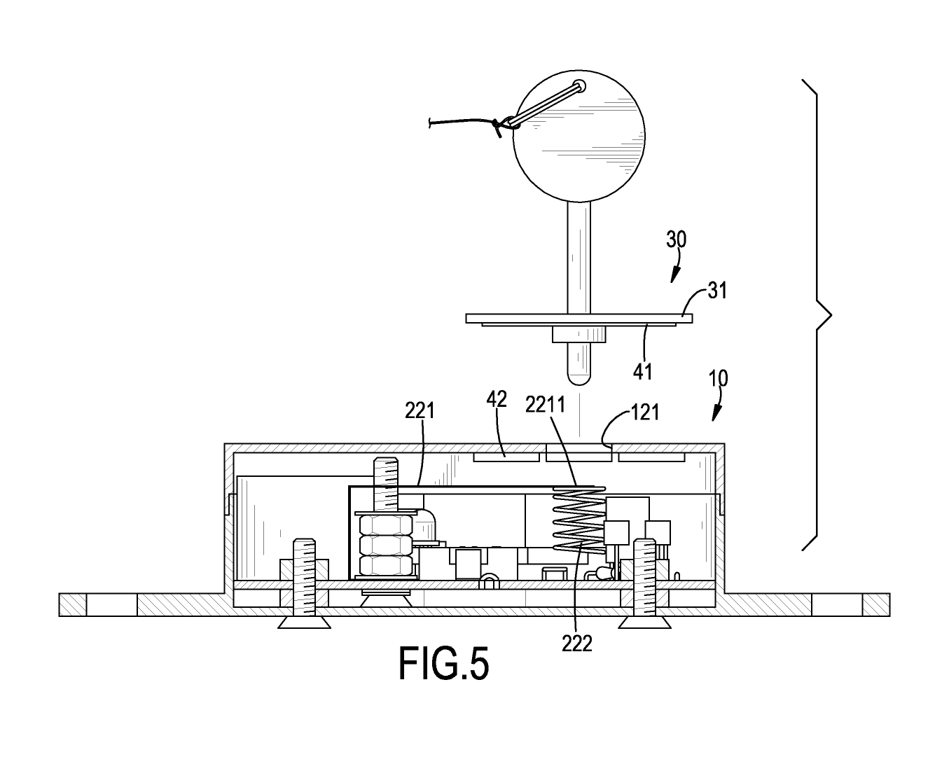

With reference to FIGS. 3 to 5, when the bolt 32 of the separator 30 is detached from the cover 12, the reed 221 is restored such that the alarm member 21 is actuated for alarming to a user.

The alarm member 21 can be an electric relay connected with a telephone dialer. When the burglar actuates the alarm device, the electric relay actuates the telephone dialer to call for help or the police.

Furthermore, the wire 70 can be preferably replaced with a transparent fishing line to provide a better covert effect.

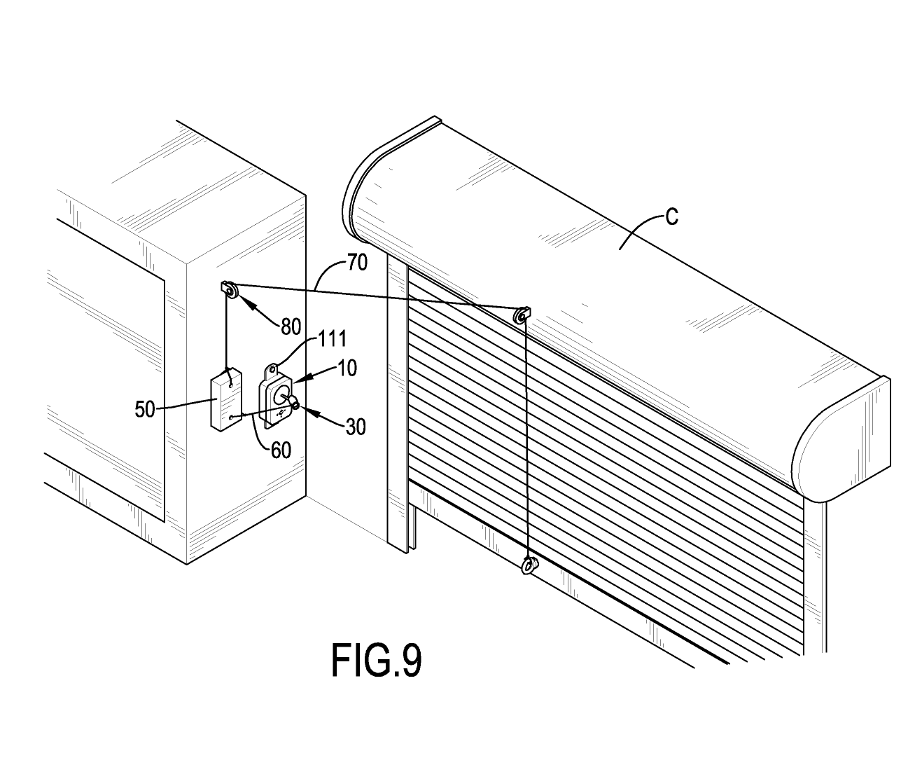

With reference to FIG. 9, the alarm device can be utilized on a rolling door C. The free end of the wire 70 is fixed on a bottom of the rolling door C and the pulley 80 is fixed on a top of the rolling door C. Therefore, the alarm device can provide a good practicability.

The metallic object 41 can be fixed on the inner side or the outer side of the cover 12 and the magnet portion 42 can be fixed on a top or a bottom of the restricting disc 31. The magnet portion 42 still can magnetically attract the metallic object 41 in an adequate distance.

The alarm device of the present invention provides the following advantages:

1) The casing 10 is positioned inside a house and the wire is connected with the door/window for providing a high concealment. Therefore, the burglar cannot easily be aware of the alarm device.

2) The alarm device can be assembled with a door plank A, a window frame B, or a rolling door C to provide a high assembling flexibility.

3) The alarm device utilizes a motion of the door/window to drop down the ballast 50 and actuate the alarm member 21. The alarm device will not cause misidentification as a conventional infrared sensor alarm does.

4) The alarm member 21 can be the electric relay and is connected with the telephone dialer, such that the electric relay actuates the telephone dialer to call for help or the police.

5) The alarm device is easy to be operated, regardless of the user's age.

6) The inner diameter of the through hole 121 is greater than each of the outer diameters of the bolt 32 and the positioning plate 33 such that the abutting end 321 of the bolt 32 can be easily detachable from the through hole 121. Therefore, the bolt 32 can be easily detached from the trigger 22 and the alarm member 21 is easily actuated.

7) When the bolt 32 is inserted into the through hole 121, the bolt 32 is kept adjacent to a center of the through hole 121 due to the positioning plate 33 sleeved on the bolt 32. The bolt 32 is correctly positioned in the through hole 121 and the trigger 22 can be precisely actuated.

8) The magnetism of the magnetic set 40 is adjustable to control a connection between the separator 30 and the casing 10 such that the separator 30 can be detached from the casing 10 according to a preset force.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A hidden burglar alarm device for a door or window comprising:
a casing;
an alarm mechanism mounted in the casing and having
an alarm member; and
a trigger connected with the alarm member; and
a separator detachably inserted into the casing and abutting against the trigger;
a magnetic set having
a metallic object fixed on the separator; and
a magnet portion fixed on the casing for magnetically attracting the metallic object; and
a connector having two ends, one of the ends fixed on the separator;
a ballast fixed on the other end of the connector; and
a flexible wire having two ends, one of the ends of the flexible wire fixed on the ballast and the other end to be fixed on a door or window.

2. The hidden burglar alarm device as claimed in claim 1, wherein the connector is a flexible wire.

3. The hidden burglar alarm device as claimed in claim 2 further comprising a pulley cooperating with the wire, wherein the wire is mounted around the pulley.

4. The hidden burglar alarm device as claimed in claim 3, wherein the casing has
an inner side on which the magnet portion is positioned; and
an outer side opposite to the inner side; and
the magnet portion includes a plurality of magnets attached on the inner side of the casing; and
the metallic object is an iron ring and is fixed on the separator for magnetically attaching on the outer side of the casing.

5. The hidden burglar alarm device as claimed in claim 4, wherein the casing has a through hole defined through the casing and located adjacent to the magnetic portion; and
the separator includes
a restricting disc provided for abutting against the outer side of the casing and having one side attached to the metallic object;
a bolt penetrating through the restricting disc to be detachably and partially inserted into the through hole in the casing and having
an abutting end provided for selectively abutting against the trigger; and
a connecting end located opposite to the abutting end to be fixed on the connector; and
a positioning plate mounted on the restricting disc and sleeved on the bolt such that the positioning plate is located between the abutting end of the bolt and the restricting disc and is selectively received in the through hole, the positioning plate having a maximum outer diameter being smaller than a minimum inner diameter of the through hole.

6. The hidden burglar alarm device as claimed in claim 5, wherein the maximum outer diameter of the positioning plate is two times greater than a minimum outer diameter of the bolt; the length of the minimum inner diameter of the through hole is 2.2 to 2.3 times of the length of the minimum outer diameter of the bolt.

7. The hidden burglar alarm device as claimed in claim 6, wherein the alarm member is a buzzer.

8. The hidden burglar alarm device as claimed in claim 1, wherein the alarm member is an electric relay.

9. The hidden burglar alarm device as claimed in claim 1, wherein the casing has
an inner side on which the magnet portion is positioned; and
an outer side opposite to the inner side; and
the magnet portion includes a plurality of magnets attached on the inner side of the casing; and
the metallic object is an iron ring and is fixed on the separator for magnetically attaching on the outer side of the casing.

10. The hidden burglar alarm device as claimed in claim 9, wherein the casing has a through hole defined through the casing and located adjacent to the magnetic portion; and
the separator includes
a restricting disc provided for abutting against the outer side of the casing and having one side attached to the metallic object;
a bolt penetrating through the restricting disc to be detachably and partially inserted into the through hole in the casing and having
an abutting end provided for selectively abutting against the trigger; and
a connecting end located opposite to the abutting end to be fixed on the connector; and
a positioning plate mounted on the restricting disc and sleeved on the bolt such that the positioning plate is located between the abutting end of the bolt and the restricting disc and is selectively received in the through hole, the positioning plate having a maximum outer diameter being smaller than a minimum inner diameter of the through hole.

11. The hidden burglar alarm device as claimed in claim 10, wherein the maximum outer diameter of the positioning plate is two times greater than a minimum outer diameter of the bolt; the length of the minimum inner diameter of the through hole is 2.2 to 2.3 times of the length of the minimum outer diameter of the bolt.

12. The hidden burglar alarm device as claimed in claim 11, wherein the alarm member is a buzzer.

13. The hidden burglar alarm device as claimed in claim 11, wherein the alarm member is an electric relay.

14. The hidden burglar alarm device as claimed in claim 1, wherein the alarm member is a buzzer.

15. The hidden burglar alarm device as claimed in claim 1, wherein the alarm member is an electric relay.
